(19) United States
(12) Patent Application Publication
(10) Pub. No.: US 2010/0284616 A1
(43) Pub. Date: Nov. 11, 2010

(54) TEETH LOCATING AND WHITENING IN A DIGITAL IMAGE

(76) Inventors: Dan Dalton, Fort Collins, CO (US); Michelle Ogg, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/810,912

(22) PCT Filed: Feb. 1, 2008
(86) PCT No.: PCT/US08/52838

§ 371 Date: Jun. 28, 2010

(51) Int. Cl. G06K 9/00

(52) U.S. Cl. 382/167

(57) ABSTRACT

A method for changing the color of teeth in a digital image is disclosed herein. An embodiment of the method comprises locating the position of a mouth region in the digital image; defining a correction zone associated with the mouth region; calculating the probability that at least one pixel in the correction zone represents a tooth; and changing the color of the at least one pixel by an amount that is proportional to the probability.

### BACKGROUND

Digital images may be edited to enhance items in the images. It is difficult to select a specific area of an image for editing, especially when the image is displayed on a small display, such as a camera display. Another problem associated with editing is that editing may change the colors of the image so much that the resulting image looks worse than the original or it may appear unrealistic. A user may not know how much color shift to apply to a given image in order to improve the image without making the image appear unrealistic.

### BRIEF DESCRIPTION OF THE DRAWINGS

FIG. 1 is a diagram of an image that includes a face.

FIG. 2 is a flow chart describing an embodiment of a teeth whitening algorithm.

FIG. 3 is a flow chart describing an embodiment of an algorithm that calculates the probability that a pixel represents a tooth.

FIG. 4 is a flow chart describing another embodiment of an algorithm that calculates the probability that a pixel represents a tooth.

FIG. 5 is an example of a mouth region of the face of FIG. 1.

FIG. 6 is a flow chart describing an embodiment of locating the top and bottom of teeth.

FIG. 7 is an example of the mouth region of FIG. 5 with the gum lines enhanced.

FIG. 8 is a flow chart describing an embodiment of locating gum lines in the mouth portion of an image.

### DETAILED DESCRIPTION

Methods for whitening teeth in a digital image are disclosed herein. It is noted that the methods may be performed by a computer or the like that executes computer-readable instructions stored on a conventional storage device, such as a magnetic or optical storage device. The storage device may also consist of firmware. In summary, some embodiments of the teeth whitening methods change the hue of the teeth or desaturate colors of the teeth without changing the hue of the face or gums. The term whitening as used herein refers to changing the colors of pixels representative of teeth, wherein the changed color may not necessarily be white.

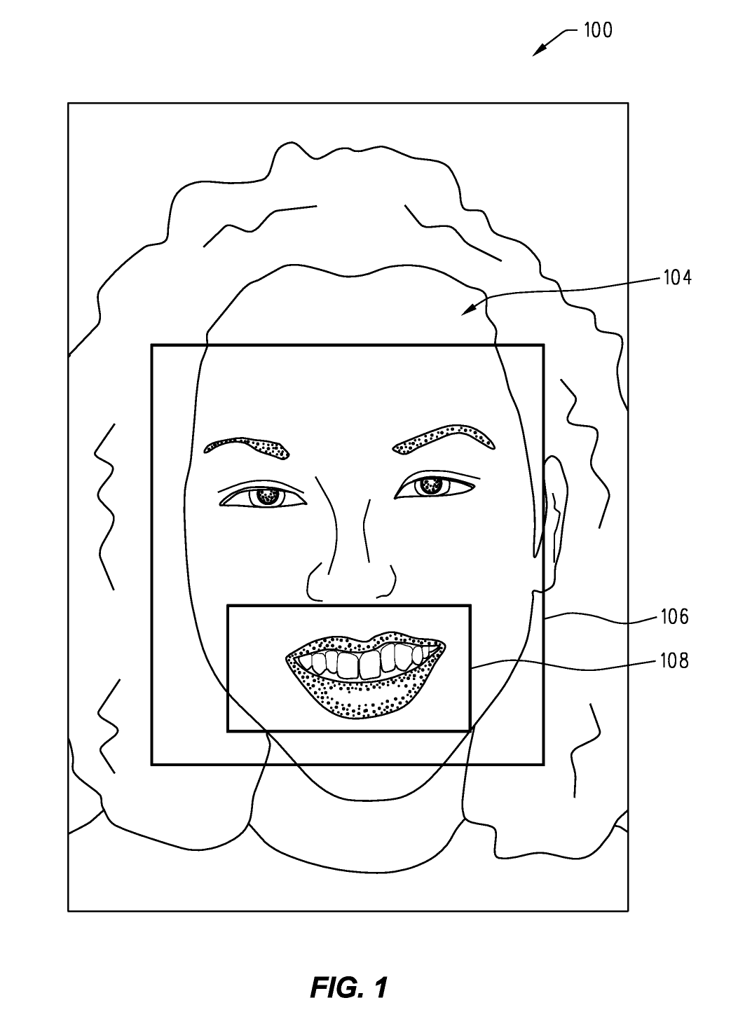

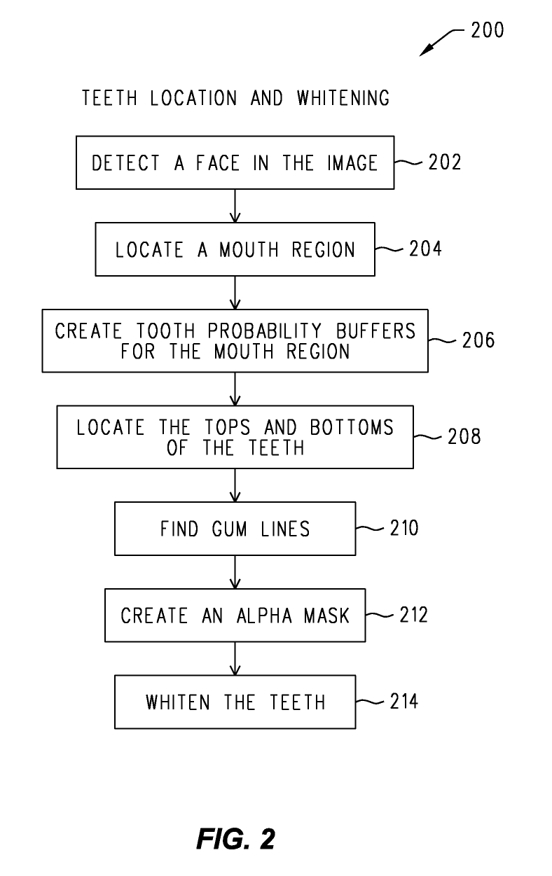

FIG. 1 is a diagram of an image 100 that includes a face 104. As described in greater detail below, the teeth in the face 104 will be located and whitened. FIG. 2 is a flow chart 200 describing an embodiment of a teeth whitening algorithm. The flow chart 200 provides a summary of the teeth whitening algorithm. More detailed embodiments of the steps of the flow chart 200 are described in greater detail below. In step 202 a face 104 is detected within the image. Conventional face detection algorithms may be used for the face detection. The face 104 is detected in FIG. 1 and is shown by the box 106.

In step 204, a mouth region 108 in the face 104 is located. More specifically, the mouth region 108 is located within the box 106. The mouth region 108 is an area where a mouth is most likely to be located. In some embodiments, the mouth region 106 is predetermined to occupy a specific region of the box 106. For example, the mouth region 108 may occupy a certain percentage of the area of the lower portion of the box 106. A box identifies the mouth region 108 located in box 106 for illustration purposes. The pixels within the mouth region 108 will be analyzed in order to find teeth and to whiten the teeth.

In step 206, the individual pixels in the mouth region 108 are analyzed and each is assigned a probability that it represents a tooth. For example a high value may represent a high probability that a pixel is part of a tooth. The analysis of step 206 may analyze the color of the pixels to determine the probability that the color is representative of a tooth. A buffer, referred to as a tooth probability buffer, is created for the pixels within the mouth region 108.

In step 208, the tops and bottoms of the teeth are located. In some embodiments, the pixels in the mouth region 108 that have a high probability of being teeth are searched to find their tops and bottoms. Thus, pixels in the mouth region 108 may be scanned in the vertical direction to determine the locations where the probabilities that the pixels are teeth transition between high and low probabilities. The transitions between high and low probabilities are representative of the edges of the teeth.

In step 210, the gum lines are located. The gum lines represent the outer boundaries of areas that are to be whitened. For example, the area between the upper gum line and the lower edges of the top teeth are to be whitened. Likewise, the area between the upper edges of the lower teeth and the lower gum line are to be whitened. As described in greater detail below, the gum lines may have gaps that represent gaps in the teeth.

In step 212, a mask, such as an alpha mask may be generated to determine the amount of whitening that is to be applied to the teeth. For example, pixels with a high probability of being teeth may be whitened or otherwise have their colors changed more than pixels with a lower probability of being teeth. Likewise, pixels proximate gum lines may be whitened less than pixels located toward the centers of teeth. Simply whitening all the teeth and all portions of the teeth evenly typically produces very unrealistic looking teeth.

In step 214, the teeth are whitened. More specifically, corrections or color changes are applied to the pixels representative of teeth. If an alpha mask is used, the amount of whitening may be based on the alpha mask. In some embodiments, the teeth are desaturated and the luminance is increased.

Having described some embodiments of whitening teeth in a digital image, more detailed embodiments will now be described. Step 204 locates a mouth region 108 of the face 104. In some embodiments, the face 104 is expected to be straight within the image 100. The size of the face 104 is measured. The mouth region 108 is then determined to be located within a predetermined portion of the face 104. In other embodiments, the mouth detection may search the face for colors representative of lips, gums, and teeth in order to locate the mouth region 108, which may not be rectangular.

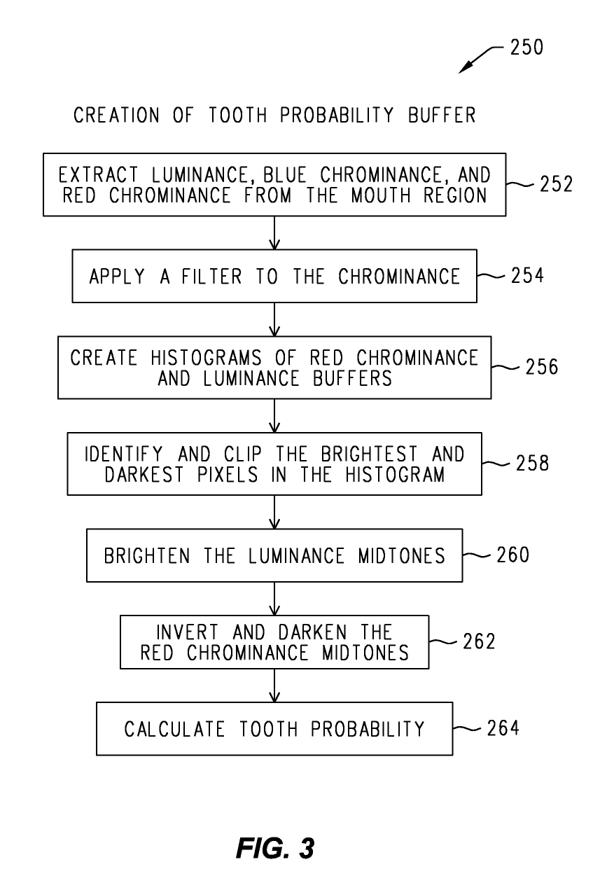

Determining the probability that pixels within the mouth region 108 are representative of teeth is sometimes referred to as determining a tooth probability buffer. An embodiment of determining the tooth probability buffer is shown in the flow chart 250 of FIG. 3. In step 252, the luminance, blue chrominance, and red chrominance are extracted from the mouth region 108. It is noted that this embodiment does not rely on the blue chrominance, however, the blue and red chrominance values are shared by adjacent pixels. In some embodiments, the luminance and chrominance values are represented by eight bits.

In step 254 a filter, such as a low-pass filter, may be applied to the red and blue chrominance to reduce noise and to smooth the buffers. The filter may be required because the red and blue chrominance values are often shared by adjacent pixels in some formats, such as the JPEG format. In some embodiments, a five by five filter is applied to the chrominance. Because of the lack of red color components in pixels representing teeth, the red chrominance appears very dark in the areas of the teeth. Lips and gums will appear much lighter with regard to the red chrominance.

In step 256, histograms of the red chrominance and luminance buffers are created. The histogram may represent pixels in a trapezoid region of the mouth region 108 in order to focus the analysis on pixels that are representative of teeth and not other facial features or background images. The brightest and darkest pixels may be clipped. In some embodiments, the pixels in the histogram are normalized between values, such as zero and 255. The brightest one percent of the pixels may be clipped to 255 and the darkest one percent of the pixels may be clipped to zero. This clipping eliminates pixel values that are much different than the other pixel values. These eliminated pixel values may be anomalies or the like.

The luminance midtones are brightened so that only the darkest pixels remain dark in step 260. Because teeth are bright, the brightening causes the pixels representative of teeth to be more prominent. In step 262, the red chrominance pixels are inverted and darkened so that only the pixels with the least amount of red remain bright. This process darkens lips and gums while enhancing the brightness of teeth.

The tooth probability is calculated at step 264. As stated above, the pixels representative of teeth have been brightened and the pixels representative of gums and lips have been darkened. Thus, the brightest pixels have the highest probability of being teeth. In the embodiment wherein the pixel values were normalized between zero and 255, the probability may be the product of the darkened red chrominance pixel values and the brightened luminance pixel values divided by 256. Thus, brighter pixel values have a higher probability of being teeth.

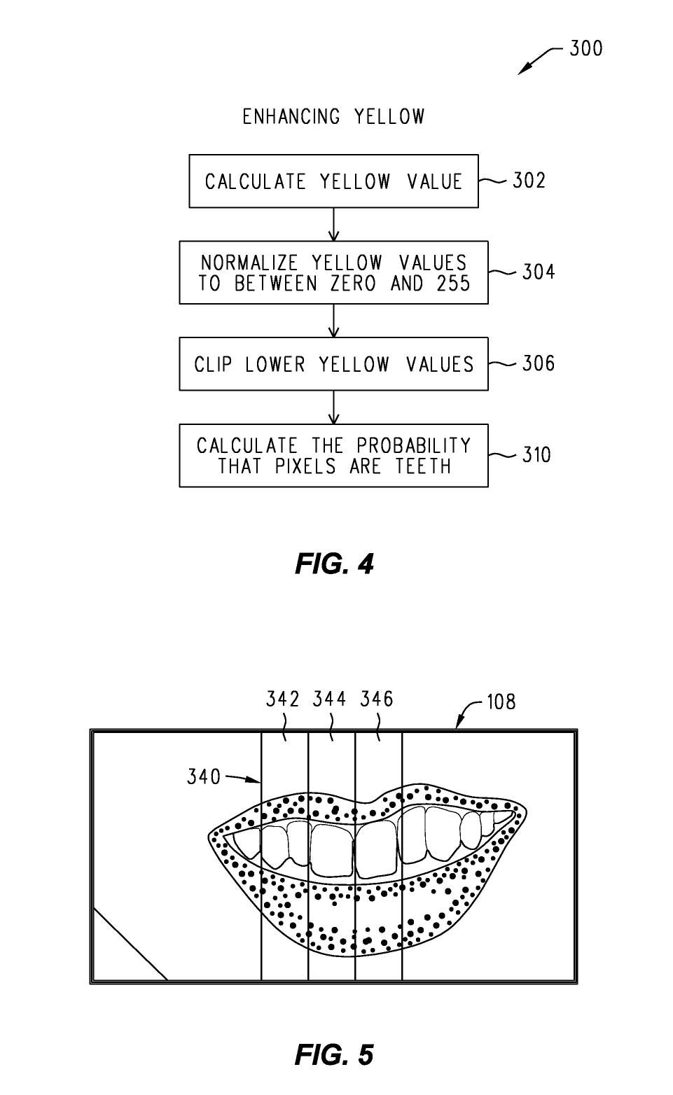

The aforementioned buffer may cause some yellows to appear dark. In some embodiments a tooth probability based on yellow may be included in the algorithm. An embodiment of this algorithm is shown in the flowchart 300 of FIG. 4. In the embodiment wherein the chrominance is normalized between zero and 255, values of red and blue chrominance of approximately 128 are neutral gray. As the blue chrominance falls below 128, the pixels becomes yellower. Likewise, as the red chrominance increases above 128, the pixels become redder. The flowchart 300 enhances the yellow in order to better detect yellow.

In step 302, a yellow value is calculated for each pixel and stored in a yellow buffer. In embodiments where the pixel values are normalized between zero and 255, the yellow value is equal to (255−blue chrominance)−red chrominance+64. The additional 64 is used to reduce clipping and may be another value. Values below zero are clipped to zero and values above 255 are clipped to 255. A histogram may be calculated and the minimum and maximum yellow values may be determined. In some embodiments, the minimum and maximum one percent of the yellow values may be determined and clipped prior to normalization in order to reduce the number of different pixel values. For example, the yellow values constituting the minimum one percent may be set to zero and the yellow values constituting the maximum one percent value may be set to 255.

In step 304, the yellow values are normalized to extend between zero and 255. In some embodiments, the yellow value that constitutes the minimum value, as calculated via the above-described histogram, is set to zero and the maximum yellow value is set to 255. It is noted that the yellow values may be extended between values other than zero and 255.

Some of the lower yellow values are clipped to black in step 306. Therefore, the pixels with low yellow content are clipped to black. For example, pixels with values below 128 may be clipped to black. In some embodiments, the maximum values of the yellow values are also limited in order to improve processing of the pixels values.

A yellow tooth probability is calculated at step 310. In the embodiment described herein, the yellow tooth probability is equal to the values of the darkened sum of the yellow buffer values and the normalized and inverted red chrominance multiplied by the normalized and brightened luminance divided by 256. The darkened sum refers to the sum, which has been darkened. Values of inverted red chrominance may be calculated as 255 minus the normalized red chrominance values. Thus, every pixel has a probability of being a tooth based on their values in the yellow buffer, wherein the higher the value, the greater the probability the pixel is representative of a tooth.

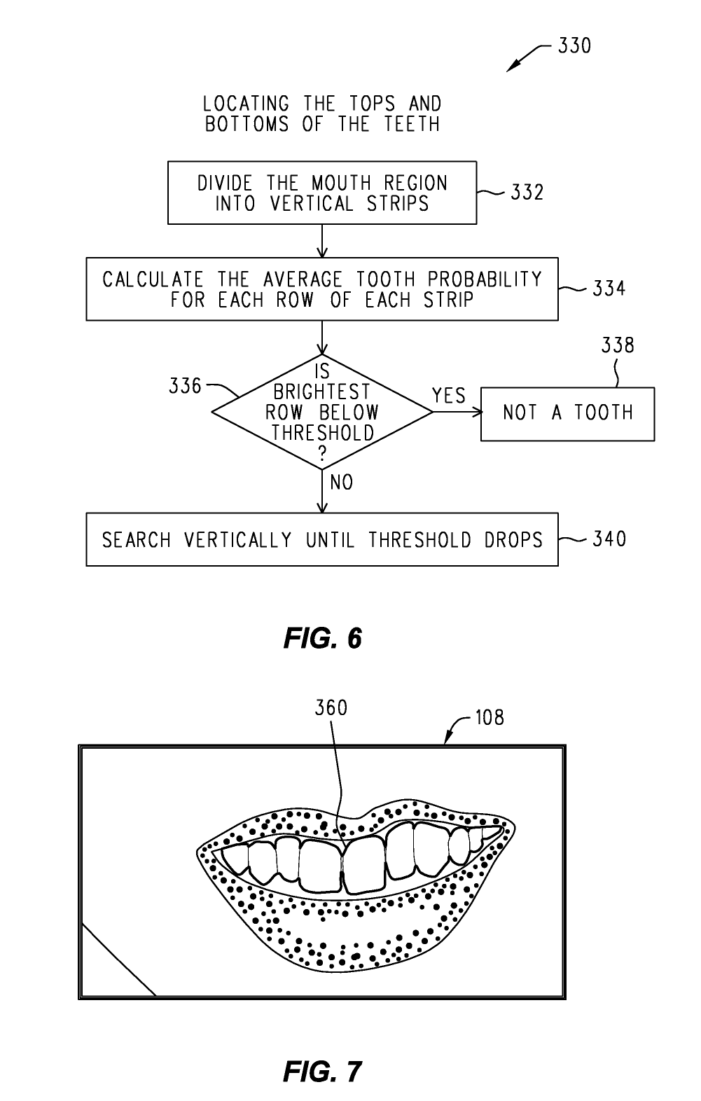

In order to limit whitening to teeth and not to other portions of the mouth region 108, the gum lines are located. Locating the gum lines involves locating the tops and bottoms of the teeth. Reference is made to FIG. 5, which is an example of a mouth portion 108, and FIG. 6, which is a flow chart 330 describing an embodiment of locating the tops and bottoms of teeth as briefly described in step 208 of FIG. 2.

In step 332 of the flow chart 330, the mouth region 108 is divided into at least one vertical strip. In some embodiments, the center region of the mouth is divided into at least one vertical strip. In the embodiment wherein the mouth region 108 has been further defined by a trapezoid, the trapezoid may be divided into at least one vertical strip. In the example of FIG. 5, the mouth region 108 has been divided into three vertical strips 340. The vertical strips 340 are referred to individually as the first strip 342, the second strip 344, and the third strip 346.

In step 334 the average probability that pixels in each row are representative of teeth are calculated for each of the strips 340. The rows refer to lines extending substantially horizontal relative to the teeth. It is noted that in images having the face or mouth region 108 skewed, the skewed face may cause the rows to be skewed. In summary, the row averages are calculated for each row in each strip. With reference to the second strip 344, the probabilities that pixels are teeth in each row are averaged. These averages are used to locate the tops and bottoms of the teeth. Step 336 determines whether the highest average is below a threshold or predetermined value. If so, processing proceeds to step 338 where a determination is made that the strip being analyzed is not a tooth or does not contain a tooth.

If the decision at step 336 determines that the brightest row is not below the threshold, processing proceeds to step 340, where the rows are searched vertically. When the average row value drops below a predetermined value, it is determined that the top or bottom of a tooth has been found. When the tops and bottoms of all the teeth have been found, the gum lines can be located. Locating the gum lines serves to prevent whitening of the gums and lips by defining the boundaries of the teeth.

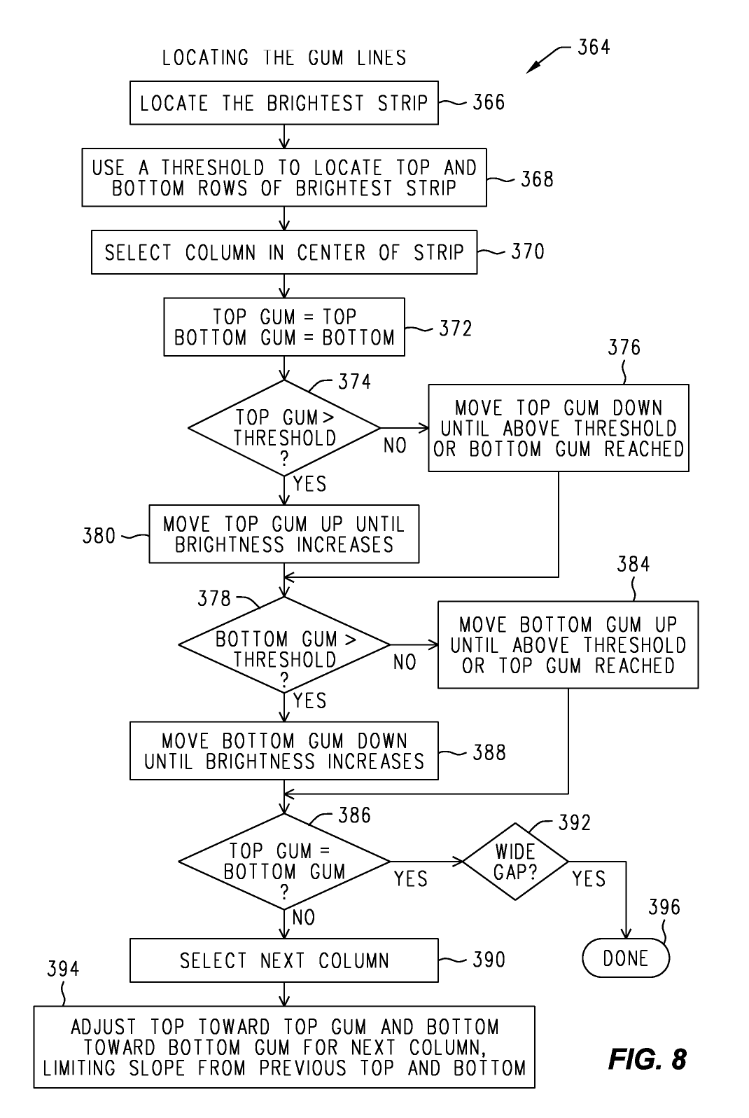

An example of a gum line 360 is shown in FIG. 7, which is an embodiment of the results of a gum line locating algorithm. The gum line 360 extends around the teeth. An embodiment of a method for locating gum lines is described in the flow chart 364 of FIG. 8. In step 366, the brightest of the strips 340, FIG. 5, is located. The brightest of the strips 340 is the strip containing the row with the highest average probabilities of containing teeth. The centers of the top and bottom rows of this strip that were located in step 340 may be used as a starting point, and the positions are stored.

The top and bottom of the brightest strip are located at step 368. In one embodiment, the pixel values are analyzed in a vertical column to determine where an upper threshold pixel value and a lower threshold pixel value are located. These locations are the designated as the top and bottom rows of the strip. In step 370, a column in the center of the strip is located. In step 372, the top of the column is designated as the top gum and the bottom of the column is designated as the bottom gum. These gum line locations correspond to the above-described thresholds.

Decision block 374 determines whether the pixel values at the top gum location are greater than a threshold. If the result of decision block 374 is negative, processing proceeds to block 376 where the top gum location is moved down until the pixel values are greater than the threshold or the bottom gum is reached. Processing then proceeds to decision block 378 as described in greater detail below. If the result of decision block 374 is affirmative, processing proceeds to block 380 where the top gum line is moved up until the pixel brightness increases. Processing then proceeds to block 378.

Decision block 378 determines whether the pixel values at the bottom gum location are greater than a predetermined threshold. If the result of decision block 378 is negative, processing proceeds to block 384 where the bottom gum is moved up until the pixel values are greater than a threshold or until the top gum location is reached. Processing then proceeds to decision block 386 as described in greater detail below. If the result of decision block 378 is affirmative, processing proceeds to block 388 where the bottom gum location is moved down until pixel brightness increases. Processing then proceeds to decision block 386.

Decision block 386 determines whether the top gum location is equal or substantially equal to the bottom gum location. This would be a situation where a column does not have pixels representative of teeth. If the result of decision block 386 is negative, processing proceeds to block 390 where the next or adjacent column is analyzed. Decision block 392 determines if the bottom and top gum locations being equal is a result of a wide gap in the teeth or the end of the gum line. If the top and bottom gum locations have been equal for a predetermined number of columns, processing proceeds to block 396 where it is terminated. Otherwise, processing proceeds to block 390 to select an adjacent or next column. Block 390 also stores the top and bottom gum locations in order to generate the gum line of FIG. 7.

From block 390, processing proceeds to block 394 where the top and bottom gum lines are adjusted. Processing then proceeds to block 372 for the adjacent or next column.

The gum line is expanded by connecting nearby peaks at step 372 in order to bridge gaps and include dark portions of teeth that may have been excluded. For example, if a peak is less than one twelfth of the width of the mouth region 108 from the next peak, the gum line may be expanded by connecting the peaks.

At this point, a tooth correction zone has been defined as extending between the gum lines and being located on pixels having a high probability of being teeth. The tooth probability buffers are converted to an alpha mask. In some embodiments, the yellow probability buffer is converted to the alpha mask. In other embodiments, the probability buffers may be combined or individually converted. The alpha mask is created by clipping pixel values below a threshold and brightening midtones. Thus, the amount of whitening applied to the each pixel between the gum lines is proportional to the probability of that pixel being a tooth.

The whitening process may include desaturating the red and blue chrominance. In some embodiments, a user input may be used to determine the amount of desaturation to be applied to the chrominance. With regard to the chrominance values described above, the amount to add to red chrominance values may be equal to the amount or percentage of desaturation, multiplied by 128 minus the red chrominance, multiplied by the value of the alpha mask and divided by 256. The blue chrominance may be modified in the same manner. The luminance may be determined by first creating a tonemap to brighten the midtones. In some embodiments, a user input may be used to determine the degree of brightening. The amount to increase the luminance may then be calculated by looking up the target luminance value in the tonemap and then subtracting the original luminance value. The difference is multiplied by the alpha mask and divided by 256.

The aforementioned technique applies whitening via desaturation and changing luminance based on the probability that a pixel is a tooth. Thus, there is a transition in whitening from the gum so that large changes tend not to occur next to the gum lines, which could make the whitening look unnatural.

The methods described above have located a gum line or the tops and bottoms of teeth and applied the teeth whitening algorithms therebetween. Other methods of locating the areas to be whitened may be used. For example, an algorithm that locates lips may be used. The whitening described above may be applied to the area between the lips. In some embodiments, the area inside the lips maybe whitened so as to avoid whitening glossy lips. This area inside the lips is sometimes referred to as the correction zone.

What is claimed is:

1. A method for changing the color of teeth in a digital image, said method comprising:
locating the position of a mouth region in said digital image;
defining a correction zone associated with said mouth region;
calculating the probability that at least one pixel in said correction zone represents a tooth; and
changing the color of said at least one pixel by an amount that is proportional to said probability.

2. The method of claim 1, and further comprising locating a face in said digital image, and wherein said locating the position of a mouth region comprises locating the position of a mouth region in said face.

3. The method of claim 1, wherein said defining a correction zone comprises locating gum lines, wherein said correction zone is at least partially defined by said gum lines.

4. The method of claim 1, wherein the said changing the color of said at least one pixel comprises applying a lesser color change to pixels located proximate the edges of teeth than to pixels not located proximate said edges of teeth.

5. The method of claim 1, wherein said calculating the probability comprises calculating the luminance and red chrominance of said pixels in said mouth region, wherein said probability is proportional to the luminance and inversely proportional to the red chrominance of said pixels.

6. The method of claim 1, wherein said calculating the probability comprises:
identifying the luminance and red chrominance of pixels in said correction zone;
brightening the luminance of pixels that are brighter than a predetermined luminance value;
brightening the pixels having red chrominance values greater than a predetermined red chrominance value; and
calculating the probability that the pixels are representative of a tooth, wherein said probability is proportional to said brightened luminance and inversely proportional to said brightened red chrominance of said pixels.

7. The method of claim 1, wherein said calculating the probability comprises:
calculating the yellow values of said pixels; and
calculating the probability that the pixels are representative of a tooth, wherein said probability is proportional to the yellow values of said pixels.

8. The method of claim 1, wherein said calculating the probability comprises:
determining the blue chrominance and the red chrominance values of said pixels; and
calculating a yellow value for each pixel, wherein said yellow value is proportional to the inverse of the blue chrominance minus the red chrominance;
calculating the probability that the pixels are representative of a tooth, wherein said probability is proportional to said yellow values.

9. The method of claim 8, and further comprising extending said red and blue chrominance values between a first number and a second number.

10. The method of claim 8, wherein said yellow value is proportional to the inverse value of the blue chrominance values minus the red chrominance values.

11. The method of claim 8, and further comprising:
eliminating at least one of the highest blue chrominance values and at least one of the lowest blue chrominance values;
eliminating at least one of the highest red chrominance values and at least one of the lowest red chrominance values;
extending the remaining blue chrominance values between a first number and a second number; and
extending the remaining red chrominance values between a first number and a second number.

12. The method of claim 8, and further comprising setting the values of yellow pixel values below a predetermined value to a lower value prior to said calculating the probability.

13. The method of claim 8, wherein said probability is proportional to the sum of the yellow values and the inverted red chrominance multiplied by the luminance and divided by a constant.

14. The method of claim 1, wherein said identifying a correction zone comprises locating lips, wherein said correction zone is located between said lips.

15. The method of claim 1, wherein said locating a correction zone comprises locating the top and bottom edges of at least one tooth within said mouth region, said correction zone being located between said top and bottom edges.

16. The method of claim 1, wherein said locating a correction zone comprises locating the top and bottom edges of at least one tooth, said locating comprising:
establishing at least one vertical strip through said mouth region; and
calculating the average probability that pixels extending in horizontal rows across said at least one vertical strip are representative of a tooth;
wherein said top and bottom edges of teeth are represented by the average probability dropping below a predetermined value.

17. The method of claim 16 and further comprising:
locating a first edge of a tooth associated with a first column of pixels;
locating a second edge of a tooth associated with a second column, said second column being adjacent said first column; and
connecting said first edge with said second edge to form a portion of said correction zone.

18. A method for changing the color of teeth in a digital image, said method comprising:
locating lips in said digital image;
calculating the probability that at least one pixel between said lips represents a tooth;
changing the color of said at least one pixel by an amount that is proportional to said probability.

19. The method of claim 18, wherein said calculating the probability comprises:
calculating the yellow values of said pixels; and
calculating the probability that the pixels are representative of a tooth, wherein said probability is proportional to the yellow values of said pixels.

20. The method of claim 18, wherein said calculating the probability comprises calculating the luminance and red chrominance of said pixels in between said lips, wherein said probability is proportional to the luminance and inversely proportional to the red chrominance of said pixels.

21. The method of claim 18, wherein said calculating the probability comprises:
identifying the luminance and red chrominance of pixels between said lips;
brightening the luminance of pixels that are brighter than a predetermined luminance value;
brightening the pixels having red chrominance values greater than a predetermined red chrominance value; and
calculating the probability that the pixels are representative of a tooth, wherein said probability is proportional to said brightened luminance and inversely proportional to said brightened red chrominance of said pixels.

22. The method of claim 18, wherein said calculating the probability comprises:
calculating the yellow values of said pixels; and
calculating the probability that the pixels are representative of a tooth, wherein said probability is proportional to the yellow values of said pixels.

23. The method of claim 18, wherein said calculating the probability comprises:
determining the blue chrominance and the red chrominance values of said pixels; and
calculating a yellow value for each pixel, wherein said yellow value is proportional to the inverse of the blue chrominance minus the red chrominance;
calculating the probability that the pixels are representative of a tooth, wherein said probability is proportional to said yellow values.
